(19) United States
(12) Patent Application Publication
(10) Pub. No.: US 2024/0335742 A1
(43) Pub. Date: Oct. 10, 2024

(54) METHOD AND DEVICE FOR VIDEO INTERACTION

(71) Applicant: Beijing Zitiao Network Technology Co., Ltd., Beijing (CN)

(72) Inventor: Zhixiong Lu, Beijing (CN)

(21) Appl. No.: 18/294,925

(22) PCT Filed: Jul. 7, 2022
(86) PCT No.: PCT/CN2022/104469

§ 371 Date: Feb. 2, 2024

(30) Foreign Application Priority Data
Aug. 4, 2021 (CN) 202110891891.4

(51) Int. Cl. A63F 13/48; A63F 13/213; A63F 13/355; A63F 13/87

(52) U.S. Cl. CPC A63F 13/48; A63F 13/213; A63F 13/355; A63F 13/87; A63F 2300/538

(57) ABSTRACT

A video interaction method includes displaying a game interface of a target game and camera-acquired pictures of multiple video call objects on a video call interface. The game interface is a share layer rendered below and/or above the camera-acquired pictures of the multiple video call objects and jointly controlling the process of the target game on the basis of game instructions of the multiple video call objects. A device, a storage medium, a computer program product, and a computer program are for performing a video interaction method.

### CROSS-REFERENCE OF RELATED APPLICATION(S)

This application claims the benefit of Chinese Patent Application No. 202110891891.4 filed on Aug. 4, 2021, entitled “METHOD AND DEVICE FOR VIDEO INTERACTION”, which is hereby incorporated by reference in its entirety.

### FIELD

Embodiments of the disclosure relate to the field of computer technology, in particular to a method, a device, a storage medium, a computer program product and a computer program for video interaction.

### BACKGROUND

With the development of technologies such as the Internet and application development, people can achieve remote video calls on social applications and get closer to each other.

During a video call, users can enhance the interest of the call by adding Augmented Reality (AR) effects to the video screen. However, AR effects are usually applied by users on their own video screen, which is less interactive.

Therefore, the interactivity of video calls needs to be improved.

### SUMMARY

Embodiments of the disclosure provide a method, a device, a storage medium, a computer program product, and a computer program for video interaction to improve interactivity of a video call.

In the first aspect, embodiments of the disclosure provide a video interaction method implemented by a terminal device. The video interaction includes displaying, at a video call interface, a game interface of a target game and camera-acquired pictures of a plurality of video call objects, wherein the game interface is a shared layer rendered below and/or above the camera-acquired pictures of the plurality of video call objects; jointly controlling a process of the target game based on game instructions of the plurality of video call objects.

In the second aspect, embodiments of the disclosure provide a device for video interactions. The device for video interactions includes a display unit, configured for displaying, at a video call interface, a game interface and camera-acquired pictures of a plurality of video call objects, wherein the game interface is a layer rendered below and/or above the camera-acquired pictures of the plurality of video call objects: a controlling unit, configured for controlling a displaying of a virtual object on the game interface, in response to game instructions triggered by recognized results of video call objects in the camera-acquired pictures.

In the third aspect, embodiments of the disclosure provide an electronic device. The electronic device includes: at least one processor and a memory. The memory stores computer executable instructions. The at least one processor executes the computer executable instructions stored in the memory, to cause the at least one processor to perform the video interaction method in the above first aspect and various possible designs of the first aspect.

In the fourth aspect, embodiments of the disclosure provide a computer-readable storage medium in which computer executable instructions are stored. When the processor executes the computer executable instructions, the video interaction method in the above first aspect and various designs of the first aspect is implemented.

In the fifth aspect, embodiments of the disclosure provide a computer program product that contains computer executable instructions. When the processor executes the computer execution instructions, the video interaction method in the above first aspect and various possible designs of the first aspect is implemented.

In the sixth aspect, embodiments of the disclosure provide a computer program that, when executed by the processor, implements a video interaction method as in the above first aspect and various possible designs of the first aspect.

### BRIEF DESCRIPTION OF THE DRAWINGS

In order to more clearly illustrate technical solutions in embodiments of the disclosure or the prior art, a brief introduction of drawings required to be used in the description of embodiments or the prior art is given below. It is obvious that the drawings in the description below are some embodiments of the disclosure. For ordinary skilled persons in the art, other drawings may also be obtained according to these drawings without creative efforts.

FIG. 1 is a first schematic diagram of an implementation scenario provided by embodiments of the disclosure;

FIG. 2 is a first flow chart of a video interaction method provided by embodiments of the disclosure;

FIG. 3 is a second schematic diagram of an implementation scenario provided by embodiments of the disclosure;

FIG. 4 is a first schematic diagram of a video call interface provided by embodiments of the disclosure;

FIG. 5 is a second schematic diagram of a video call interface provided by embodiments of the disclosure;

FIG. 6 is a third schematic diagram of a video call interface provided by embodiments of the disclosure;

FIG. 7 is a first flow chart of a video interaction method provided by embodiments of the disclosure;

FIG. 8 is a structure diagram of a target detection device provided by embodiments of the disclosure;

FIG. 9 is a schematic diagram of hardware structure of an electronic device provided by embodiments of the disclosure.

### DETAILED DESCRIPTION

In order to make the purpose, technical scheme and advantages of the disclosure clearer, the technical scheme in the disclosure will be clearly and completely described below in conjunction with the drawings of the disclosure. Obviously, described embodiments are a part of embodiments of the disclosure, not entire embodiments. Based on embodiments in the disclosure, all other embodiments obtained by ordinary skilled persons in the field without creative efforts fall within the scope of protection of the disclosure.

Usually, in a video chat, users can add some AR special effects on their own screen, which is not interactive enough. Therefore, the interactivity between users in the video chat needs to be improved.

In order to solve the above problems, embodiments of the disclosure provide a method and device for video interaction. According to the method, the video call interface displays a game interface and camera-acquired pictures of a plurality of video call objects, and the game interaction is realized at the same time of the video call. On the one hand, the game interface is a shared layer rendered above and/or below the camera-acquired pictures of the plurality of video call objects, and the shared layer below the camera-acquired pictures of the plurality of video call objects can be regarded as a background of the camera-acquired pictures of the plurality of video call objects. The shared layer above the camera-acquired pictures of the plurality of video call objects can be regarded as an element superimposed on the camera-acquired pictures of the plurality of video call objects, so that the game interface can span across the camera-acquired pictures of the plurality of video call objects, thereby improving a combination effect of the game interface with the camera-acquired pictures of the plurality of video call objects and a displaying effect of the game interface. Especially, larger game scene can be displayed on the game interface, which is advantageously to improve the interactivity. On the other hand, during game interactions, a process of the target game can be jointly controlled based on game instructions of the plurality of video call objects. Thus, the plurality of video call objects can jointly play the same game during the video call, and the process of the game is controlled by the plurality of video call objects, which effectively improves the interactivity and interest.

The method and device are based on the same application concept, since the method and device solve the problem in similar principles, embodiments of the method and device can be referred to each other, redundant parts are omitted.

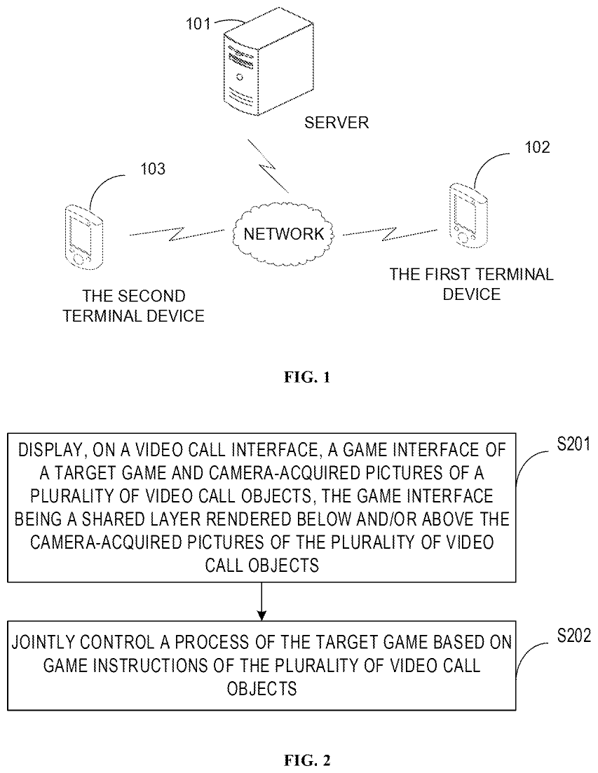

Referring to FIG. 1, FIG. 1 is a schematic diagram of an implementation scenario provided by embodiments of the disclosure.

The implementation scenario shown in FIG. 1 is a video call scenario. In the video call scenario, involved devices include a plurality of terminal devices and a server 101, and the terminal devices and the server 101 can communicate with each other through a network. In FIG. 1, the plurality of terminal devices, including the first terminal device 102 and the second terminal deice 103, are taken as an example. A user at the first terminal device 102 and a user at the second terminal device 103 are video call objects and video chat with each other.

In the video call scenario, the server 101 obtains camera-acquired pictures and game input data uploaded by the first terminal device 102 and the second terminal device 103. After the camera-acquired pictures and the game input data are processed, the camera-acquired pictures of the first terminal device 102 is sent to the second terminal device 103 for displaying, the camera-acquired pictures of the second terminal device 103 is sent to the first terminal device for displaying, and the processed game data is sent to the first and second terminal devices 102 and 103, respectively, to update a game interface displayed on the first and second terminal devices 102 and 103. All of the processing of the game data can be conducted at the server 101, a part of the processing of the game data can be carried out at terminal device(s).

As an example, the video interaction method provided by embodiments of the disclosure can be applied to the terminal device. The terminal device may be a personal digital assistant (PDA) device, a handheld device with wireless communication function (such as, a smart phone, a tablet computer), a computing device (such as, a personal computer (PC)), an on-board device, a wearable device (such as, a smart watch, a smart wristband), and smart home devices (such as, smart display devices). The video call scenario involves a plurality of terminal devices, and each terminal device can carry out the following embodiments of the methods.

Referring to FIG. 2, FIG. 2 is the first flow chart of a video interaction method provided by embodiments of the disclosure. As shown in FIG. 2, the video interaction method includes:

At S201, a game interface of a target game and camera-acquired pictures of a plurality of video call objects are displayed on a video call interface. The game interface is rendered in a shared layer below and/or above the camera-acquired pictures of the plurality of video call objects.

The target game is a multi-player game with strong interactivity.

The plurality of video call objects is a plurality of end users who is making the video call. In a scenario of multi-participants video call, the number of video calls is greater than or equal to 2. The camera-acquired pictures of the plurality of video call objects are those taken by the cameras on the terminals where the plurality of video call objects locates, and may also be called video pictures.

During the video call, a video call interface is displayed on the terminal device. For example, the video call interface includes a call background (such as, a black background picture) and some operable icons (such as, a speaker icon and a call end icon). After the terminal device obtains the pictured taken by the camera of its own video call object and those camera-acquired pictures of other video call objects sent by the server in real time, the terminal device may display the camera-acquired pictures of the plurality of video call objects on the corresponding positions of the video call interface to implement the video call.

During the video call, the terminal device can start and run the target game requested by the video call object, when receiving a game request from the video call object, and display a game interface of the target game and camera-acquired pictures of the plurality of video call objects in real time on the video call interface. Optionally, during the video call, the video call object can trigger the game request by voice, touch screen, and the like. For example, the video call object can trigger the game request by taping a game icon displayed at the edge of the video call interface.

In an example embodiment, after the target game is started during the video call, the game interface of the target game and the camera-acquired pictures of the plurality of video call objects can be displayed on the video call interface. The game interface can be a shared layer rendered below or above the camera-acquired pictures of the plurality of video call objects, and the number of shared layers can be one or more.

In the case of rendering the game interface as a shared layer under the pictures taken by the plurality of video call objects, the camera-acquired pictures of a plurality of game call objects are distributed on the shared layer, the shared layer is the game interface and can be regarded as the whole or a part of the call background. In the case of rendering the game interface as a shared layer above the pictures taken by the plurality of video call objects, the shared layer can be regarded as an element superimposed on the pictures taken by a plurality of cameras. After rendering, the game interface can span across the camera-acquired pictures of the plurality of video call objects. In other words, a displaying area of the game interface includes a displaying area of the pictures taken by the video call objects, rather than superimposing an individual game interface on a single picture taken by a single camera, respectively. The rendering method of the above mentioned game interface, on one hand, is advantageous to improve display effects of the game interface, especially for rendering the game interface with large game scenes, and on the other hand, provides a whole game interface for the plurality of video call objects, rather than providing an individual game interface, which is conducive to improving interaction effects.

At S202, based on game instructions of the plurality of video call objects, a process of the target game is jointly controlled.

In this embodiment, each video call object can input a game instruction on the respective terminal device where they are, control the process of the target game together through the game instruction, and update the displaying of the target game in real time on the terminal. Specifically, the current terminal device can obtain game input data of the video call object on its own side and send the game input data to the server. The server may synthesize the game inputs from the terminals where each video call object resides, process a game logic, and return the game data after processing to each terminal. Each terminal may update the process of the target game according to the game data, including updating the displaying of the game interface of the target game. The game input data may include the game instruction. Thus, the interactivity of the video call is improved by superimposing the game interaction on the video chat. In particular, instead of processing the game instructions of different video call objects separately to control the game process of the target game on different terminals, this embodiment synthesizes the game instructions of the plurality of video call objects to jointly control the process of the target game, thereby effectively enhancing the interactivity of multi-people participating in the same game during the video call.

Optional, on one hand, a transmission speed of camera-acquired pictures is different from a speed of game input data. Generally, the camera-acquired pictures include many pixels, the data amount is large and the transmission speed is relatively low, and the data amount of the game input data is small, which can be transmitted in bytes, and the transmission is faster, resulting in that the camera-acquired pictures and the game input data arriving at the server time is not synchronized. The game input data usually arrives at the server earlier than the camera-acquired pictures. On the other hand, an upload frame rate of the camera-acquired pictures is different from an upload frame rate of the game input data. The upload frame rate of the game data can reach a higher frame rate, while the camera-acquired pictures are limited by camera qualities and the upload frame rate is limited. Therefore, in order to improve the synchronization of the game interaction and the video call and fluency of the game, timestamp synchronization is performed on the camera-acquired pictures and the game input data at the server, that is, the timestamp synchronization is carried out on a video stream and the game input data.

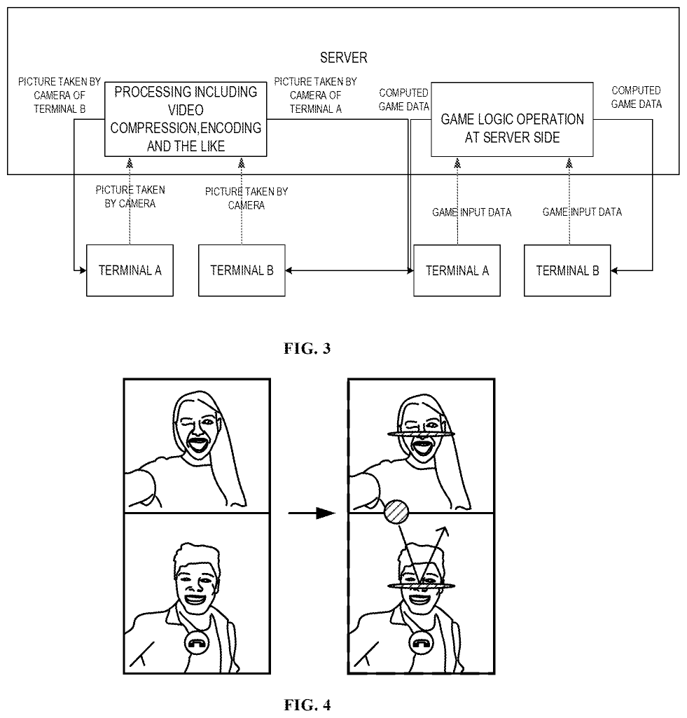

Referring to FIG. 3, FIG. 3 is a second schematic diagram of an implementation scenario provided by embodiments of the disclosure. Taking the terminal A and the terminal B to realize the game interaction on the basis of the video call as an example. FIG. 3 shows an interaction procedure among the terminal A, the terminal B and the server according to embodiments of the disclosure. In FIG. 3, the terminal A and the terminal B may upload camera-acquired pictures and game input data to the server, respectively. The server may compress and decode camera-acquired pictures, perform a game logic operation on the server side based on the game input data. The server may synchronize time stamps the camera-acquired pictures and the game input data. After the synchronization, the processed picture taken by the terminal A may be sent to the terminal B, the processed picture taken by the terminal B may be sent to the terminal A, and the computed game data may be sent to the terminal A and the terminal B.

In the video interaction method provided by embodiments of the present embodiment, the game interface of the target game and the pictures taken by the plurality of video call objects are displayed on the video call interface, and on the basis of providing a plurality of video call services to the plurality of video call objects, an interactive game is provided to the plurality of video call objects to participate together. Thus, the interactive effect of the game is improved by using the video call. Similarly, the interactive effect of the video chat process is improved by using the game controlled by multiple people.

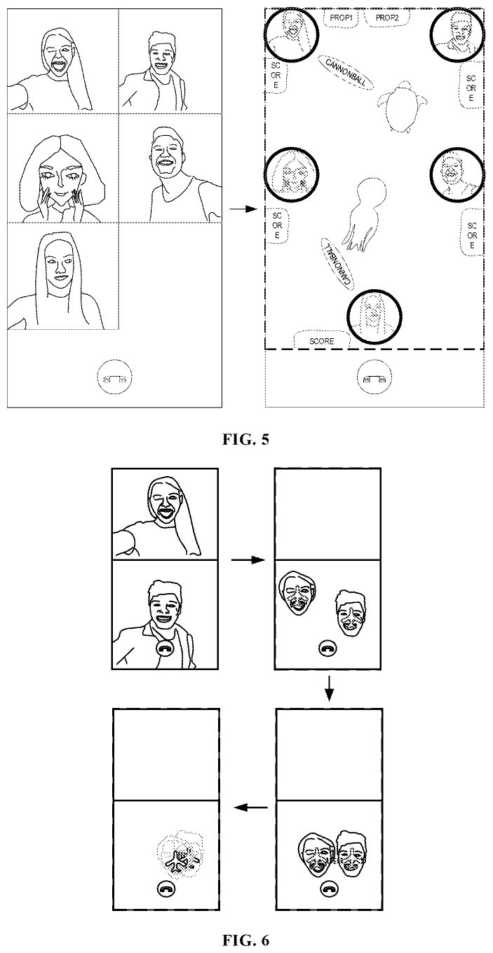

Referring to FIG. 4 to FIG. 6, FIG. 4 is a first schematic diagram of a video call interface provided by embodiments of the disclosure, FIG. 5 is a second schematic diagram of a video call interface provided by embodiments of the disclosure, and FIG. 6 is a third schematic diagram of a video call interface provided by embodiments of the disclosure. FIG. 4 to FIG. 6 show the video call interface before and after the game is started, respectively. In FIG. 4 and FIG. 5, the figure on the left shows the video call interface before the game is started and the figure on the right shows the video call interface after the game is started. In FIG. 6, the first figure shows the video call interface before the game is started, the last three figures show the video call interface varies with changes of positions of the video call object after the game is started. Combined with the video call interface shown in FIG. 4 to FIG. 6, the displaying of the video call interface is described through a plurality of embodiments below.

In some embodiments, the displaying of the game interface on the video call interface includes adapting to a size of an area of the video call interface, rendering the game interface. Thus, it can adapt to a situation where the sizes of the area of the video call interface on different terminals may be different, and the size of the area of the video call interface on the same terminal may change, thereby flexibly adjusting the size of the game interface, and improving the display effects of the game interface.

Optionally, the size of the area of the game interface is proportional to the size of the area of the video call interface, and the size of the area of the game interface is smaller than the size of the area of video call interface.

When the size of the area of the video call interface is adapted to render the game interface, the game scene can be displayed in the video call interface according to the proportion relationship, and the area of game scene is smaller than the area of the video call and interface. For example, the area of the game scene in FIG. 5 is smaller than the area of the video call interface, where a dotted line box in FIG. 5 is the area of the game scene.

Optionally, the size of the game scene is equal to the size of the video call interface, or the game scene is aligned with the video call interface. On one hand, it is helpful to provide a large display area for the game interface as much as possible. On the other hand, on the terminal side, for the plurality of video call objects, the game interface is a whole interface, which facilitates to realize more game interactions and improve video interactivity.

When rendering the game interface in accordance with the size of the area of the video call interface, the game interface is rendered with the size of the area of the video call interface. In other words, the game interface is rendered aligned with the video call interface. For example, in FIG. 4 and FIG. 6, the game scene is aligned with the area of the video call interface, where the dashed box area in FIG. 4 and FIG. 6 is the area of the game scene.

In some embodiments, the displaying of the camera-acquired pictures of the plurality of video call objects on the video call interface includes determining a plurality of video areas based on the video call interface: in the plurality of video areas, displaying the camera-acquired pictures of the plurality of video call. The video area can be understood as a video window, which is used to display real-time updated camera-acquired pictures to ensure the process of the video call.

Optionally, one way to determine the plurality of video areas on the video call interface includes: dividing the video call interface into the plurality of video areas arranged according to rows and/or columns. When dividing the video call interface, the number of required video areas may be determined according to the number of video call objects. The plurality of divided video areas may be used for displaying pictured taken by different video call objects, respectively. For example, when the number of video call objects is 2, the video call interface can be horizontally divided to obtain 2 video areas arranged in above and below. Alternatively, the video call interface can be vertically divided to obtain 2 video areas arranged in left and right.

For example, in FIG. 4, the video call interface is horizontally divided into 2 video areas arranged up and down, and the camera-acquired pictures of 2 video call objects are respectively displayed in the 2 divided video areas. The game interface can be rendered above the camera-acquired pictures of 2 video call objects.

Optionally, another way to determine the plurality of video areas on the video call interface includes determining a plurality of discretely distributed video areas on the video call interface. The discretely distributed video areas can be set to adapt to an area where a virtual character locates in the game interface. Thus, the flexibility of video area setting can be improved, the combination of video area and the game interface can be improved.

In addition, the plurality of discretely distributed video areas locates at an edge of the game interface. Thus, on one hand, an obstacle of the video area to the game interface can be reduced: on the other hand, the game interface can be rendered as the background of the video call interface, which improves the rendering effect of the game interface, especially for rendering the game interface with large scenes, and more than 3 video areas can be distributed at the edge of the game interface, which facilitates more than 3 video call objects to participate in the target game and improving the interactivity.

For example, in FIG. 5, 5 circular video areas are discretely distributed on the video call interface and are distributed at the edge of the game interface. The camera-acquired pictures of the video call objects are displayed in the 5 video areas, and the game interface is displayed in the dotted line box area of the video call interface. In this way, the camera-acquired pictures of the video call objects displayed in the 5 video areas realize the video call of the 5 video call objects, and at the same time, it conforms to the position of the players in the game interface, thereby improving the combination effects of the video call and game interaction.

Optionally, one way to display the camera-acquired pictures of the plurality of video call subjects in the plurality of video areas includes: displaying pictures taken by different video call objects on different video areas. For example, when two video call objects in FIG. 4 are having the video call, the camera-acquired pictures of different video call objects are respectively displayed in two video areas. When five video call objects in FIG. 5 are having the video call, the camera-acquired pictures of different video call objects are respectively displayed in five video areas.

Optionally, another way to display the camera-acquired pictures of the plurality of video call objects on the plurality of video areas includes individually extracting a plurality of target images from the camera-acquired pictures of the plurality of video call objects: displaying the target images of different video call objects on different video areas, and/or displaying the target images of the plurality of video call objects in a same video area. Thus, based on the size of the video area and/or a need of the game interaction, a part of the target image may be selected from the camera-acquired pictures to display in the video area to improve the combination effects of the video area and the game interface, and then to improve the interaction effects.

The target image can be a facial image, a hand image, an eye image and the like. In one way, considering ensuring the effect of the video call and the game interaction based on the facial image, the facial image can be extracted from the camera-acquired pictures of the video call object, and the facial image of the video call object is displayed in the video area. In the other way, considering the case of the game interaction based on hand movements, eye expressions and the like, the target image (such as, the hand images and the eye image) may be extracted from the camera-acquired pictures of the video call object, and the extracted target may can be displayed in the video area.

For example, in FIG. 5, the camera-acquired pictures of the video call objects may be displayed in the 5 video areas, and facial images extracted from the camera-acquired pictures of the video call objects may also be displayed in the 5 video areas.

In a way of displaying the target image of the plurality of video call objects in the same video area, after the target game is started, the plurality of target images may be extracted from the camera-acquired pictures of the plurality of video call objects displayed in different video areas before the game. The plurality of target images may be displayed in the same video area. Thus, to adapt to the interactive needs of the game, flexibility of the displaying of the target image of the video call object can be adjusted flexibly.

For example, in FIG. 6: in the video call interface before starting the game, the camera-acquired pictures of 2 video call objects are respectively displayed in 2 horizontally divided video areas: facial images are extracted from the camera-acquired pictures of 2 video call objects in the video call interface after starting the game: adapted to a position of an aircraft on the game interface, the facial images of the two video call objects are displayed in the lower video area of the two video areas.

It should be noted that various displaying ways of the game interface in above embodiments and various display ways of the camera-acquired pictures of the video call objects can be combined with each other to obtain the video call interface, which is diversity, flexible and conducive to improve the interactivity.

On the basis of any of above embodiments, in some embodiments, a content presented by the game interface includes a game scene image and/or a controllable virtual object. The game scene picture may be a shared layer rendered below the camera-acquired pictures of the plurality of video call objects, and the controllable virtual object may be a shared layer rendered above the game scene picture, or above the camera-acquired pictures of the plurality of video call objects, or above the video call interface. Thus, rendering effects of the target game is improved, when the game interface includes controllable virtual objects, the interactivity of video call may be improved by controlling the virtual objects of the plurality of video call objects.

For example, the game background picture may be rendered on the video call interface as shown in FIG. 4 to FIG. 6 to obtain the game scene image. The controllable virtual objects may include, for example, a ping-pong ball in FIG. 4, a racket at the nose of the video call object on the camera-acquired pictures, a cannonball that can be controlled by the video call object in FIG. 5, and an aircraft that can be moved by the video call object in FIG. 6.

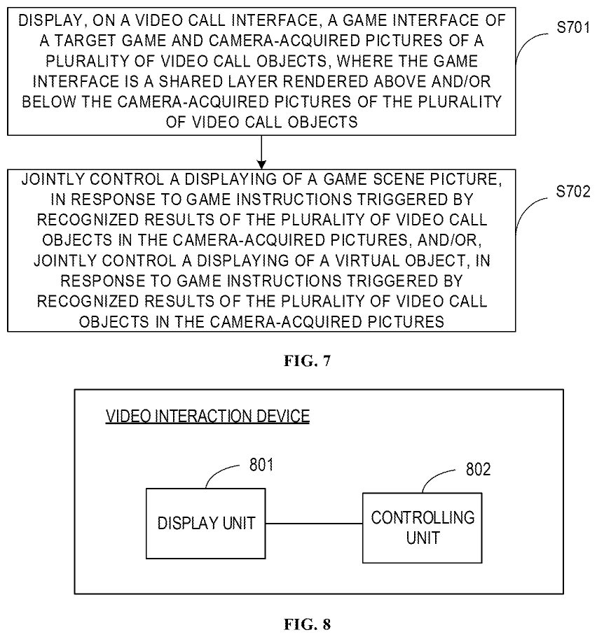

The content presented by the game interface based on the target game may include the game scene image of the target game and/or the controllable virtual object. Referring to FIG. 7, FIG. 7 is a first flow chart of a video interaction method provided by embodiments of the disclosure. As shown in FIG. 7, the video interaction method includes:

At S701, a game interface of a target game and pictures taken by a plurality of video call objects are displayed on a video call interface, where the game interface is a shared layer rendered above and/or below the pictures taken be the cameras of the plurality of video call objects.

The implementation principle and technical effect of S701 can be referred to above embodiments, which are omitted here.

At S702, a displaying of a game scene picture is jointly controlled, in response to game instructions triggered by recognized results of the plurality of video call objects in the camera-acquired pictures, and/or, a displaying of a virtual object is jointly controlled, in response to game instructions triggered by recognized results of the plurality of video call objects in the camera-acquired pictures.

In this embodiment, for each video call object, the game instructions of the video call object can be triggered by the recognized result obtained from recognizing the camera-acquired pictures of the video call object. The server may recognize the camera-acquired pictures of the video call object, to obtain the recognized results, and may determine the game instructions corresponding to the recognized result, and transmit the game instructions to the terminal for execution. Alternatively, the server may execute the game instructions and send the execution result to each terminal, and each terminal may update the displaying of the game interface according to the execution result.

In this embodiment, the content displayed on the video call interface of the target game may include in the case of the game scene image of the target game, the displaying of the game scene image can be jointly controlled in response to the game instructions triggered by the recognized results of the plurality of video call objects in the respective camera. And/or, the content displayed on the video call interface of the target game may include in the case of the controllable virtual object, the displaying of the virtual object may be jointly controlled in response to the game instructions triggered by the recognized results of the plurality of video call objects in the respective camera. Thus, the joint controlling on the process of the target game can be realized, from one or two aspects, such as the joint controlling of the game scene image display and the joint controlling of displaying the virtual object.

Optionally, controlling the displaying of the game scene may include at least one of: controlling a switch between game scenes, controlling displaying special effects on the game scene. For example, in response to the recognized results of the plurality of video call objects, a switching may be performed between different competitive game scenes. Alternatively, during an interaction game for taking photos, the switching may be performed between different multi-people taking photos scenes. Alternatively, “high five” and “thumb up” interactive special effects and other scene effects may be displayed to break boundaries of time and space.

Optionally, controlling the displaying of the virtual object may include controlling various displaying ways of the virtual object and controlling not to display the virtual object. For example, in FIG. 6, the displaying and not displaying of the virtual object “cannonball” can be controlled.

Optionally, the recognized result of the plurality of video call objects in the camera-acquired pictures may include at least one of: expressions of the video call objects in the camera-acquired pictures, face positions of the video call objects in the camera-acquired pictures, body movements of the video call objects in the camera-acquired pictures, a relative position of different video call objects in the camera-acquired pictures. Thus, based on expression recognition, face recognition, body movement recognition and the like on the camera-acquired pictures, the virtual object can be controlled by the video call objects through the changes of facial expressions, changes of face positions, changes of body movements and changes of relative positions on the video call interface, to realize jointly controlling the game process, thereby improving interactivity.

For example, when recognizing a movement of palm waving of the video call object, a game instruction for switching game scenes may be triggered. As an example, when recognizing that directions of the palms of the video call objects satisfy a condition where palms are facing each other, the interactive effect of “high five” may be triggered. As another example, when recognizing that directions of faces of the video call objects satisfy a condition where faces are facing each other, the displaying of a corresponding shooting scene may be triggered.

In some embodiments, during jointly controlling the displaying of the virtual object in response to the game instructions triggered by the recognized results of the plurality of video call objects in the camera-acquired pictures, a displacement, shape, movement of the virtual object and/or a corresponding game skill may be controlled in response to the game instructions triggered by the recognized results of the plurality of video call objects in the camera-acquired pictures. That is, controlling various display ways of the virtual object may include controlling one or more of: the displacement of the virtual object, the shape of the virtual object, the movement of the virtual object, or the corresponding game skill of the virtual object. Thus, by the recognition of the video call objects in the camera-acquired pictures, the virtual object can be controlled in a variety of ways to improve the interactivity of the video game.

Taking FIG. 4 to FIG. 6 as an example: (1) in FIG. 4, positions of the noses of the video call objects may be further recognized by recognizing positions of faces of the video call objects in the camera-acquired pictures, a position control instruction on the racket may be triggered by the positions of the noses, the racket and the ping-pong ball are both virtual objects, the displacement of the racket in the game interface may be controlled based on the position control instruction, the displacement of the racket in the game interface may have effect on a displacement of the ping-pong ball in the game interface, the displacement of the ping-pong ball may be further controlled to realize an interactive game “playing table tennis” between two video interactive objects: (2) in FIG. 5, the game skill corresponding to the virtual object “cannonball” may be triggered by recognizing facial expressions, face positions and so on of the video call objects in the camera-acquired pictures, the position of “cannonball” may be displayed on the game interface, a launching direction may also be displayed, for example, users may control the launching direction of cannonball by nodding, shaking or turning heads to other directions, it realizes that five video call objects interact in the same game and control the process of the same game: (3) in FIG. 6, facial images may be extracted from the camera-acquired pictures and may be displayed in the same video area, the displacement of the aircraft may be controlled by recognizing positions of facial images in the video call interface, a change of the shape of the aircraft may be triggered according to relative positions of different facial images in the video call interface. Among them, when two facial images are getting close or overlapped in FIG. 6, a curve between two aircrafts may show mutual influences and interactions between the two aircrafts.

For example, the movement of the virtual object may include, such as, jumping obstacle of virtual characters in some games.

In some embodiments, different video call objects correspond to different virtual objects. During jointly controlling displaying of virtual objects in response to the game instructions triggered by the recognized results of the plurality of video call objects in the camera-acquired pictures, for each video call object, the displaying of the corresponding virtual object may be controlled in response to the game instructions triggered by the recognized results of the plurality of video call objects in the camera-acquired pictures. Thus, during jointly controlling the game process of the target game, different video call objects may control the displaying of different virtual objects, to improve interactive effects of the game. For example, different video call objects may control the displaying of different ping-pong balls in FIG. 4, different video call objects may control the displaying of different cannonballs in FIG. 5, and different video call objects may control the displaying of different aircrafts in FIG. 6.

In addition to triggering the game instructions based on the recognized results of the video call objects in the camera-acquired pictures, optionally, the video call object can also trigger the game instructions by a voice command, a button, a touch screen and other ways to improve the flexibility of game control during the video call.

In addition to controlling the virtual object by the video call object, optionally, the displaying of the virtual object may also control positions of the camera-acquired pictures of the video call object in the video call interface. For example, in FIG. 6, the video call object can control the displacement of the aircraft by means of keyboard, touch screen, and the like. As the displacement of the aircraft changes, the position of the facial image extracted from the camera-acquired picture of the corresponding video call object in the video call interface may be updated.

In addition to the game scene of the target game and the controllable virtual object in the target game, optionally, the game interface of the target game may present game data such as game props, game grades and game rankings of the target game, to improve the display effect of the game interface. For example, the game interface in FIG. 5 may show game scores of each video call object, and may also show the game props “Prop 1” and “Prop 2”.

Corresponding to the video interaction method of above embodiments, FIG. 8 is a structure diagram of a target detection device provided by embodiments of the disclosure. For purposes of illustrations, only the parts relevant to embodiments of the disclosure are shown. Referring to FIG. 8, the device for video interaction includes: a display unit 801 and a controlling unit 802.

The display unit 801 is configured for displaying, at a video call interface, a game interface of a target game and camera-acquired pictures of a plurality of video call objects, where the game interface is a shared layer rendered below and/or above the camera-acquired pictures of the plurality of video call objects.

The controlling unit 802 is configured for jointly controlling a process of the target game based on game instructions of the plurality of video call objects.

In an embodiment of the disclosure, the display unit 801 is specifically configured for rendering the game interface in subject to a size of the video call interface.

In an embodiment of the disclosure, display unit 801 is specifically configured for: determining a plurality of video areas on the video call interface: displaying the camera-acquired pictures of the plurality of video call objects on the plurality of video areas.

In an embodiment of the disclosure, the display unit 801 is specifically configured for dividing the video call interface into the plurality of video areas arranged according to row and/or column.

In an embodiment of the disclosure, the display unit 801 is specifically configured for determining a plurality of discretely distributed video areas on the video call interface, the plurality of discretely distributed video areas located at an edge of the game interface.

In an embodiment of the disclosure, the display unit 801 is specifically configured for extracting a plurality of target images from the camera-acquired pictures of the plurality of video call objects, respectively: displaying the plurality of target images in a same video area.

In an embodiment of the disclosure, a content presented on the game interface includes a game scene picture and/or a controllable virtual object, the controlling unit 802 is specifically configured for in response to game instructions triggered by recognized results of the plurality of video call objects in the camera-acquired pictures, jointly controlling a displaying of the game scene picture; and/or in response to game instructions triggered by recognized results of the plurality of video call objects in the camera-acquired pictures, jointly controlling a displaying of the virtual object.

In an embodiment of the disclosure, different video call objects correspond to different virtual objects, and the controlling unit 602 is specifically configured for: for each individual video call object, in response to the game instructions triggered by recognized results of the plurality of video call objects in the camera-acquired pictures, jointly controlling a displaying of the corresponding virtual object.

In an embodiment of the disclosure, the control unit 802 is specifically configured for in response to the game instructions triggered by recognized results of the plurality of video call objects in the camera-acquired pictures, controlling a displacement, a shape, a movement of the virtual object and/or a corresponding game skill.

In an embodiment of the disclosure, the recognized results of video call objects in the camera-acquired pictures include at least one of: expressions of the video call objects in the camera-acquired pictures, face positions of the video call objects in the camera-acquired pictures, body movements of the video call objects in the camera-acquired pictures, a relative position of different video call objects in the camera-acquired pictures.

The device provided by embodiments of the disclosure can be used to execute the technical scheme of above method embodiments, the implementation principle and technical effect are similar, which are omitted here.

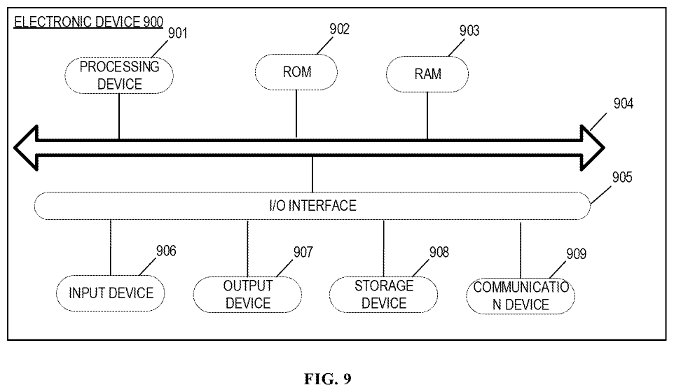

Reference is made to FIG. 9, which shows a schematic diagram of an electronic device 900 suitable for implementing embodiments of the disclosure. The electronic device 900 may be a terminal device or a server. The terminal device may include, but not limited to, digital terminals, such as, a mobile phone, a laptop computer, a digital broadcast receiver, a personal digital assistant (PDA), a portable android device (PAD), a portable media player (PMP), a vehicle terminal (such as, an on-board navigation terminal) and the like, and fixed terminals, such as, a digital TV, a desktop computer and the like. The electronic device shown in FIG. 9 is only an example and should not bring any limitation on the functionality and use scope of the disclosure.

As shown in FIG. 9, the electronic device 900 may include a processing device (e.g. a central processing unit, a graphics processing unit, etc.) 901, which perform various proper acts and processing according to program(s) stored in a read only memory (ROM) 902 or program(s) loaded from a storage unit 908 to a random access memory (RAM) 903. There are various programs and data required for operation(s) of the electronic device 900 stored in the RAM 903. The processing unit 901, the ROM 902 and the RAM 903 may be interconnected with each other via a bus 904. An input/output (I/O) interface 905 is also connected to the bus 904.

Generally, the following devices can be connected to the I/O interface 905: an input device 906 including, for example, a touch screen, a touchpad, a keyboard, a mouse, a camera, a microphone, an accelerometer, a gyroscope and the like: an output device 907 including, for example, a liquid crystal display (LCD), a speaker, a vibrator and the like; a storage device 908 including, for example, a tap or a hard disk; and a communication device. The communication device 909 may allow the electronic device 900 to communicate wirelessly or wired with other devices to exchange data. Although FIG. 9 shows an electronic device 900 with various devices, it should be understood that it is not required to implement or have all of the devices shown. More or fewer devices may be implemented or possessed instead.

In particular, according to embodiments of the disclosure, the process described with the reference to the above flow chart may be implemented as a computer software program. For example, embodiments of the disclosure include a computer program product that includes a computer program carried on a computer readable medium that contains program codes for performing a method shown in the flow chart. In such embodiments, the computer program may be downloaded and installed from a network via the communication device 909, or from the storage device 908, or from the ROM 902. When the computer program is executed by the processing device 901, the above functions defined in methods of the disclosure are performed.

It shall be noted that the computer readable medium of the disclosure may be a computer readable signal medium or a computer readable storage medium or any combination of the two. A computer readable storage medium, for example, may be, but is not limited to, an electrical, magnetic, optical, electromagnetic, infrared, or semiconductor system, device, or equipment, or any combination of the above. More specific examples of computer readable storage media may include but are not limited to: an electrical connection with one or more wires, a portable computer disk, a hard disk, a random access memory (RAM), a read only memory (ROM), an erasable electrical programmable read only memory (EPROM or flash memory), an optical fiber, a portable compact disc read only memory (CD-ROM), an optical storage device, a magnetic storage device, or any suitable combination of the above. For purposes of this disclosure, the computer readable storage medium may be any tangible medium containing or storing a program that may be used by or in combination with an instruction executing system, device, or a device. In the disclosure, however, the computer-readable signal medium may include a data signal propagated in a baseband or as part of a carrier that carries the computer-readable program code. Such propagated data signals may take many forms, including but not limited to electromagnetic signals, optical signals, or any suitable combination of the above. The computer-readable signal medium may also be any computer-readable medium other than the computer-readable storage medium that may send, propagate or transmit a program intended for use by or in combination with an instruction executing system, device or equipment. The program code contained on the computer readable medium may be transmitted in any appropriate medium, including but not limited to: an electrical wire, an optical cable, radio frequency (RF), and the like, or any suitable combination of the above.

The computer readable medium may be included in the above mentioned electronic device. Alternatively, the computer readable medium may stand alone and not be incorporated into the electronic device.

The computer readable medium may carry one or more programs which, when executed by the electronic device, causes the electronic device to perform the method shown in above embodiments.

Computer program code for performing operations of the disclosure may be written in one or more programming languages or combinations thereof, including object-oriented programming languages such as Java, Smalltalk, C++, and conventional procedural programming languages such as the “C” language or similar programming languages. The program code may be executed entirely on the user's computer, partly on the user's computer, as a stand-alone software package, partly on the user's computer and partly on a remote computer, or entirely on a remote computer or server. In the case involving a remote computer, the remote computer may be connected to the user computer over any kind of Network, including a local area network (LAN) or a wide area network (WAN), can be connected to an external computer (e.g., using an Internet service provider to connect over the Internet).

The flow charts and block diagrams in the drawings illustrate the possible implementations of architecture, functions, and operations of the systems, methods, and computer program products in accordance with various embodiments of the disclosure. In this regard, each box in the flow charts or block diagrams may represent a module, a program segment, or a part of code that contains one or more executable instructions for implementing a specified logical function. It should also be noted that in some alternative implementations, the functions indicated in the boxes may also occur in a different order than those indicated in the accompanying diagram. For example, two boxes represented one after another can actually be executed basically in parallel, and they can sometimes be executed in reverse order, depending on the function involved. Note also that each of the boxes in the block diagram and/or flowchart, and the combination of the boxes in the block diagram and/or flowchart, can be implemented with a dedicated hardware-based system that performs the specified function or operation, or with a combination of dedicated hardware and computer instructions.

Units involved in the description of embodiments described herein may be implemented either by means of software or by means of hardware. The name of the unit does not limit the unit itself in certain circumstances, for example, the first obtaining unit may also be described as “a unit that obtains at least 2 Internet protocol addresses”.

The functions described herein can be performed, at least in part, by one or more hardware logical units. For example, non-restrictively, demonstration types of hardware logic parts that can be used may include: a field programmable gate array (FPGA), an application specific integrated circuit (ASIC), an application specific standard parts (ASSP), a system on Chip (SOC), a complex programmable logic device (CPLD), and the like.

In the context of the disclosure, a machine-readable medium may be a tangible medium that may contain or store a program for use by or in conjunction with an instruction executing system, equipment or device. The machine-readable medium may be a machine-readable signaling medium or a machine-readable storage medium. The machine-readable media may include, but are not limited to, electronic, magnetic, optical, electromagnetic, infrared, or semiconductor systems, apparatus, or devices, or any suitable combination of the above. More specific examples of machine-readable storage media would include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices magnetic storage devices, or any suitable combination of the above.

In the first aspect, according to one or more embodiments of the disclosure, a video interaction method is provided, which is implemented by a terminal device and includes: displaying, on a video call interface, a game interface of a target game and camera-acquired pictures of a plurality of video call objects, wherein the game interface is a shared layer rendered below and/or above the camera-acquired pictures of the plurality of video call objects: jointly controlling a process of the target game based on game instructions of the plurality of video call objects.

According to one or more embodiments of the disclosure, the displaying of the game interface includes rendering the game interface in subject to a size of the video call interface.

According to one or more embodiments of the disclosure, the displaying of the camera-acquired pictures of the plurality of video call objects on the video call interface includes: determining a plurality of video areas on the video call interface: displaying the camera-acquired pictures of the plurality of video call objects on the plurality of video areas.

According to one or more embodiments of the disclosure, determining the plurality of video areas on the video call interface includes dividing the video call interface into the plurality of video areas arranged according to row and/or column.

According to one or more embodiments of the disclosure, determining the plurality of video areas on the video call interface includes determining a plurality of discretely distributed video areas on the video call interface, the plurality of discretely distributed video areas located at an edge of the game interface.

According to one or more embodiments of the disclosure, displaying the camera-acquired pictures of the plurality of video call objects on the plurality of video areas includes extracting a plurality of target images from the camera-acquired pictures of the plurality of video call objects, respectively: displaying the plurality of target images in a same video area.

According to one or more embodiments of the disclosure, a content presented on the game interface includes a game scene picture and/or a controllable virtual object, jointly controlling the process of the target game based on the game instructions of the plurality of video call objects includes in response to game instructions triggered by recognized results of the plurality of video call objects in the camera-acquired pictures, jointly controlling a displaying of the game scene picture; and/or in response to game instructions triggered by recognized results of the plurality of video call objects in the camera-acquired pictures, jointly controlling a displaying of the virtual object.

According to one or more embodiments of the disclosure, different video call objects correspond to different virtual objects, in response to the game instructions triggered by recognized results of the plurality of video call objects in the camera-acquired pictures, jointly controlling the displaying of the virtual object includes for each individual video call object, in response to the game instructions triggered by recognized results of the plurality of video call objects in the camera-acquired pictures, jointly controlling a displaying of the corresponding virtual object.

According to one or more embodiments of the disclosure, in response to the game instructions triggered by recognized results of the plurality of video call objects in the camera-acquired pictures, jointly controlling the displaying of the virtual object includes in response to the game instructions triggered by recognized results of the plurality of video call objects in the camera-acquired pictures, controlling a displacement, a shape, a movement of the virtual object and/or a corresponding game skill.

According to one or more embodiments of the disclosure, the recognized results of video call objects in the camera-acquired pictures include at least one of: expressions of the video call objects in the camera-acquired pictures, face positions of the video call objects in the camera-acquired pictures, body movements of the video call objects in the camera-acquired pictures, a relative position of different video call objects in the camera-acquired pictures.

In the second aspect, according to one or more embodiments of the disclosure, a device for video interaction is provided, which is applicable to a terminal device and includes:
a display unit configured for displaying, on a video call interface, a game interface of a target game and camera-acquired pictures of a plurality of video call objects, wherein the game interface is a shared layer rendered below and/or above the camera-acquired pictures of the plurality of video call objects;
a controlling unit configured for jointly controlling a process of the target game based on game instructions of the plurality of video call objects.

According to one or more embodiments of the disclosure, the displaying unit is specifically configured for rendering the game interface in subject to a size of the video call interface.

According to one or more embodiments of the disclosure, the displaying unit is specifically configured for: determining a plurality of video areas on the video call interface: displaying the camera-acquired pictures of the plurality of video call objects on the plurality of video areas.

According to one or more embodiments of the disclosure, the displaying unit is specifically configured for dividing the video call interface into the plurality of video areas arranged according to row and/or column.

According to one or more embodiments of the disclosure, the displaying unit is specifically configured for determining a plurality of discretely distributed video areas on the video call interface, the plurality of discretely distributed video areas located at an edge of the game interface.

According to one or more embodiments of the disclosure, the displaying unit is specifically configured for: extracting a plurality of target images from the camera-acquired pictures of the plurality of video call objects, respectively: displaying the plurality of target images in a same video area.

According to one or more embodiments of the disclosure, a content presented on the game interface includes a game scene picture and/or a controllable virtual object, the control unit is specifically configured for in response to game instructions triggered by recognized results of the plurality of video call objects in the camera-acquired pictures, jointly controlling a displaying of the game scene picture; and/or in response to a game instructions triggered by recognized results of the plurality of video call objects in the camera-acquired pictures, jointly controlling a displaying of the virtual object.

According to one or more embodiments of the disclosure, different video call objects correspond to different virtual objects, the control unit is specifically configured for: for each individual video call object, in response to the game instructions triggered by recognized results of the plurality of video call objects in the camera-acquired pictures, jointly controlling a displaying of the corresponding virtual object.

According to one or more embodiments of the disclosure, the control unit is specifically configured for in response to the game instructions triggered by recognized results of the plurality of video call objects in the camera-acquired pictures, controlling a displacement, a shape, a movement of the virtual object and/or a corresponding game skill.

According to one or more embodiments of the disclosure, the recognized results of video call objects in the camera-acquired pictures include at least one of: expressions of the video call objects in the camera-acquired pictures, face positions of the video call objects in the camera-acquired pictures, body movements of the video call objects in the camera-acquired pictures, a relative position of different video call objects in the camera-acquired pictures.

In this third aspect, according to one or more embodiments of the disclosure, an electronic device is provided, including: at least one processor and a memory: the memory storing computer executable instructions: the at least one processor executing the computer executable instructions stored in the memory, causing the at least one processor to execute the video interaction method of the first aspect or various designs of the first aspect.

In the fourth aspect, according to one or more embodiments of the disclosure, a computer readable storage medium is provided, where the computer readable storage medium stores computer executable instructions, and when a processor executes the computer executable instructions, the video interaction method of the first aspect or various designs of the first aspect.

In the fifth aspect, according to one or more embodiments of the disclosure, an electronic device is provided. The electronic device includes at least one processor and a memory: the memory storing computer executable instructions: the at least one processor executing the computer executable instructions stored in the memory, causing the at least one processor to execute the video interaction method of the first aspect or various designs of the first aspect.

In the sixth aspect, according to one or more embodiments of the disclosure, a computer readable storage medium is provided. The computer readable storage medium stores computer executable instructions, and when a processor executes the computer executable instructions, the video interaction method of the first aspect or various designs of the first aspect.

In the seventh aspect, according to one or more embodiments of the disclosure, a computer program product is provided. The computer program product contains computer executable instructions, and when a processor executes the computer executable instructions, the video interaction method of the first aspect or various designs of the first aspect.

In the eighth aspect, according to one or more embodiments of the disclosure, a computer program is provided. The computer program product contains computer executable instructions, and when a processor executes the computer executable instructions, the video interaction method of the first aspect or various designs of the first aspect.

The above description is only a better understanding of the disclosure and an explanation of the technical principles used. It should be understood by those skilled in the art that the scope of the disclosure is not limited to technical solutions resulting from a particular combination of the aforesaid technical features, but shall also cover other technical solutions resulting from any combination of the aforesaid technical features or their equivalents without being separated from the aforesaid disclosed ideas. For example, the technical scheme formed by the substitution of the above features with the technical features disclosed in this disclosure (but not limited to) having similar functions.

In addition, although operations are described in a particular order, this should not be construed as requiring that those operations be performed in the particular order shown or in a sequential order. In certain circumstances, multitasking and parallel processing may be advantageous. Again, although certain implementation details are included in the above discussion, these should not be interpreted as limiting the scope of this disclosure. Certain features described in the context of individual embodiments may also be realized in combination in a single embodiment. Conversely, various features described in the context of a single embodiment may also be realized in multiple embodiments individually or in any suitable sub combination.

Although the subject matter has been described in language specific to structural features and/or methodological logical actions, it should be understood that the subject matter defined in the attached claims is not necessarily limited to the specific features or actions described above. Rather, the specific features and actions described above are merely example forms of implementing the claims.

1. A video interaction method implemented by a terminal device, comprising:
displaying, on a video call interface, a game interface of a target game and camera-acquired pictures of a plurality of video call objects, the game interface being a shared layer rendered below and/or above the camera-acquired pictures of the plurality of video call objects; and
jointly controlling a process of the target game based on game instructions of the plurality of video call objects.

2. The video interaction method of claim 1, wherein the displaying of the game interface on the video call interface comprises:
rendering the game interface in subject to a size of the video call interface.

3-15. (canceled)

16. The video interaction method of claim 2, wherein the displaying of the camera-acquired pictures of the plurality of video call objects comprises:
determining a plurality of video areas on the video call interface; and
displaying the camera-acquired pictures of the plurality of video call objects on the plurality of video areas.

17. The video interaction method of claim 2, wherein a content presented on the game interface comprises a game scene picture and/or a controllable virtual object, jointly controlling the process of the target game based on the game instructions of the plurality of video call objects comprises:
in response to game instructions triggered by recognized results of the plurality of video call objects in the camera-acquired pictures, jointly controlling a displaying of the game scene picture; and/or
in response to game instructions triggered by recognized results of the plurality of video call objects in the camera-acquired pictures, jointly controlling a displaying of the virtual object.

18. The video interaction method of claim 1, wherein the displaying of the camera-acquired pictures of the plurality of video call objects comprises:
determining a plurality of video areas on the video call interface; and
displaying the camera-acquired pictures of the plurality of video call objects on the plurality of video areas.

19. The video interaction method of claim 18, wherein determining the plurality of video areas on the video call interface comprises:
dividing the video call interface into the plurality of video areas arranged according to row and/or column.

20. The video interaction method of claim 18, wherein determining the plurality of video areas on the video call interface comprises:
determining a plurality of discretely distributed video areas on the video call interface, the plurality of discretely distributed video areas located at an edge of the game interface.

21. The video interaction method of claim 18, wherein displaying the camera-acquired pictures of the plurality of video call objects on the plurality of video areas comprises:
extracting a plurality of target images from camera-acquired pictures of the plurality of video call objects, respectively; and
displaying the plurality of target images in a same video area.

22. The video interaction method of claim 18, wherein a content presented on the game interface comprises a game scene picture and/or a controllable virtual object, jointly controlling the process of the target game based on the game instructions of the plurality of video call objects comprises:
in response to game instructions triggered by recognized results of the plurality of video call objects in the camera-acquired pictures, jointly controlling a displaying of the game scene picture; and/or
in response to game instructions triggered by recognized results of the plurality of video call objects in the camera-acquired pictures, jointly controlling a displaying of the virtual object.

23. The video interaction method of claim 1, wherein a content presented on the game interface comprises a game scene picture and/or a controllable virtual object, jointly controlling the process of the target game based on the game instructions of the plurality of video call objects comprises:
in response to game instructions triggered by recognized results of the plurality of video call objects in the camera-acquired pictures, jointly controlling a displaying of the game scene picture; and/or
in response to game instructions triggered by recognized results of the plurality of video call objects in the camera-acquired pictures, jointly controlling a displaying of the virtual object.

24. The video interaction method of claim 23, wherein different video call objects correspond to different virtual objects, in response to the game instructions triggered by recognized results of the plurality of video call objects in the camera-acquired pictures, jointly controlling the displaying of the virtual object comprises:
for each individual video call object, in response to the game instructions triggered by recognized results of the plurality of video call objects in the camera-acquired pictures, jointly controlling a displaying of the corresponding virtual object.

25. The video interaction method of claim 24, wherein in response to the game instructions triggered by recognized results of the plurality of video call objects in the camera-acquired pictures, jointly controlling the displaying of the virtual object comprises:
in response to the game instructions triggered by recognized results of the plurality of video call objects in the camera-acquired pictures, controlling a displacement, a shape, a movement of the virtual object and/or a corresponding game skill.

26. The video interaction method of claim 24, wherein the recognized results of video call objects in the camera-acquired pictures comprises at least one of:
expressions of the video call objects in the camera-acquired pictures,
face positions of the video call objects in the camera-acquired pictures,
body movements of the video call objects in the camera-acquired pictures, or
a relative position of different video call objects in the camera-acquired pictures.

27. The video interaction method of claim 23, wherein in response to the game instructions triggered by recognized results of the plurality of video call objects in the camera-acquired pictures, jointly controlling the displaying of the virtual object comprises:
in response to the game instructions triggered by recognized results of the plurality of video call objects in the camera-acquired pictures, controlling a displacement, a shape, a movement of the virtual object and/or a corresponding game skill.

28. The video interaction method of claim 27, wherein the recognized results of video call objects in the camera-acquired pictures comprises at least one of
expressions of the video call objects in the camera-acquired pictures,
face positions of the video call objects in the camera-acquired pictures,
body movements of the video call objects in the camera-acquired pictures, or
a relative position of different video call objects in the camera-acquired pictures.

29. The video interaction method of claim 23, wherein the recognized results of video call objects in the camera-acquired pictures comprises at least one of:
expressions of the video call objects in the camera-acquired pictures,
face positions of the video call objects in the camera-acquired pictures,
body movements of the video call objects in the camera-acquired pictures, or
a relative position of different video call objects in the camera-acquired pictures.

30. An electronic device, comprising:
at least one processor and a memory;
the memory storing computer executable instructions; and
the at least one processor executing the computer executable instructions stored in the memory, causing the at least one processor to perform a video interaction method comprising:
display, on a video call interface, a game interface of a target game and camera-acquired pictures of a plurality of video call objects, the game interface being a shared layer rendered below and/or above the camera-acquired pictures of the plurality of video call objects; and
jointly control a process of the target game based on game instructions of the plurality of video call objects.

31. The electronic device of claim 30, wherein the electronic device is caused to display the camera-acquired pictures of the plurality of video call objects by:
determining a plurality of video areas on the video call interface; and
displaying the camera-acquired pictures of the plurality of video call objects on the plurality of video areas.

32. The electronic device of claim 30, wherein a content presented on the game interface comprises a game scene picture and/or a controllable virtual object, and wherein the electronic device is caused to jointly control the process of the target game based on the game instructions of the plurality of video call objects by:
in response to game instructions triggered by recognized results of the plurality of video call objects in the camera-acquired pictures, jointly controlling a displaying of the game scene picture; and/or
in response to game instructions triggered by recognized results of the plurality of video call objects in the camera-acquired pictures, jointly controlling a displaying of the virtual object.

33. A non-transitory computer readable storage medium storing computer executable instructions, and when a processor executes the computer executable instructions, a video interaction method is performed, wherein the video interaction method comprises:
displaying, on a video call interface, a game interface of a target game and camera-acquired pictures of a plurality of video call objects, the game interface being a shared layer rendered below and/or above the camera-acquired pictures of the plurality of video call objects; and
jointly controlling a process of the target game based on game instructions of the plurality of video call objects.
